(19) United States
(12) Patent Application Publication
(10) Pub. No.: US 2013/0231432 A1
(43) Pub. Date: Sep. 5, 2013

(54) CONCRETE CRACK AND JOINT SEALANT AND METHOD

(71) Applicant: Bartholomew S. Pharr, Mount Airy, NC (US)

(72) Inventor: Bartholomew S. Pharr, Mount Airy, NC (US)

(73) Assignee: MARKETING ASSOCIATES, INC., Mount Airy, NC (US)

(21) Appl. No.: 13/412,561

(22) Filed: Mar. 5, 2012

(51) Int. Cl. C08K 3/30; C09D 153/02; C08K 3/26; C09D 123/20; C08K 3/22; C08K 3/34

(52) U.S. Cl. 524/423; 524/431; 524/447; 524/442; 524/424; 524/425; 524/427; 524/579; 524/505

(57) ABSTRACT

Crack and joint sealant and method, an embodiment of the crack and joint sealant having a composition that is both gray and meets certain ASTM standards.

### FIELD OF THE INVENTION

This invention is related to sealants, and more particularly to crack and joint sealants for concrete and roads.

### BACKGROUND OF THE INVENTION

A crack or joint in a concrete roadway may be filled with a crack and joint sealant, such as an ASTM-D6690 Type II crack and joint sealant. Currently, there are hundreds of millions of pounds of black ASTM-D6690 Type II crack and joint sealant in the road.

However, concrete roadways are generally gray in color. Thus, a concrete roadway that is sealed with a black or very dark ASTM-D6690 Type II crack and joint sealant may be aesthetically unpleasant. Furthermore, the contrast in colors of the crack and joint sealant and concrete may distract drivers on freeways and other roads, introducing safety concerns. Since millions of miles of concrete road have cracks and expansion or other joints that need to be and will be sealed every year, there is an opportunity to provide a solution that may overcome those drawbacks.

Applying crack and joint sealant that is the same color as the concrete to which it is being applied may address those issues. Various civic officials and transportation engineers have therefore requested use of a crack and joint sealant that has a color closer to that of the concrete to which it is being applied.

Though gray crack and joint sealants may have been produced and marketed, no such sealant is believed to have met the ASTM-DD690 Type II specification. Therefore, those sealants cannot be applied to roads such as those that include Portland cement concrete and asphaltic concrete pavements.

Accordingly, there may be a need for a gray crack and joint sealant that complies with the ASTM-D6690 Type II specification and is lighter and closer to the color of the roads and pavements in which it is to be applied than existing black or very dark crack and joint sealants. There may also be a need for such a gray crack and joint sealant that complies with the ASTM-D6690 Type I or III specification.

### BRIEF DESCRIPTION OF THE DRAWINGS

The accompanying drawing, wherein like reference numerals are employed to designate like components, is included to provide a further understanding of gray crack and joint sealants, is incorporated in and constitutes a part of this specification, and illustrates embodiments of a gray crack and joint sealant that together with the description serve to explain the principles of gray crack and joint sealants.

Various other objects, features and advantages of the invention will be readily apparent according to the following description exemplified by the drawing, which are shown by way of example only, wherein:

FIG. 1 illustrates an embodiment of a road with a crack and joint filled with a crack and joint sealant.

### DETAILED DESCRIPTION

Reference will now be made to embodiments of gray crack and joint sealants, examples of which are illustrated in the accompanying drawings. Details, features, and advantages of the gray crack and joint sealants will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

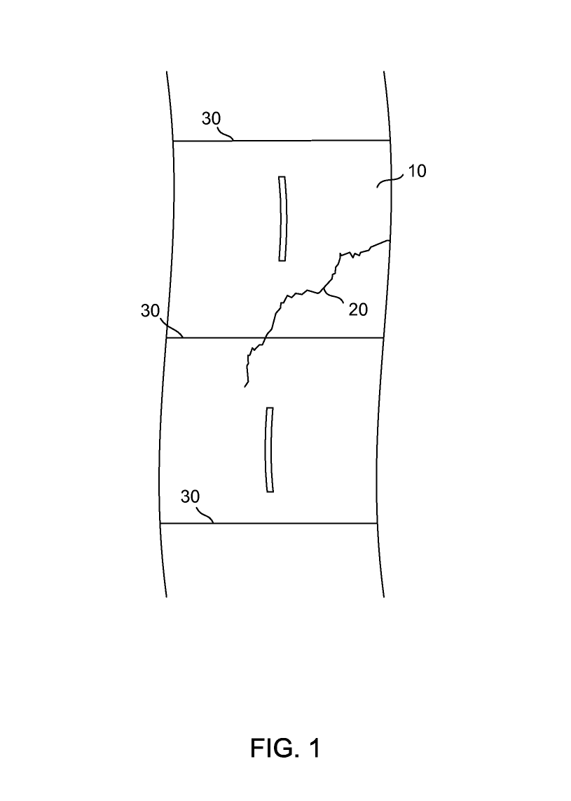

FIG. 1 illustrates a roadway 10 having a crack 20 and joints 30, in accordance with one embodiment. The roadway in the embodiment illustrated in FIG. 1 is made, at least in part, of concrete, though it may be reinforced with steel and may include other materials as desired or to meet various requirements for the roadway 10. In an embodiment, the roadway includes, at least in part, Portland cement concrete or asphaltic concrete pavement. That roadway may be light gray or gray in color.

The crack 20 and joints 30, such as expansion joints, in the roadway 10 may be filled with a crack and joint sealant, such as an ASTM-D6690 Type II-compliant crack and joint sealant. A gray ASTM-D6690 Type II-compliant crack and joint sealant, embodiments of which are described herein, may be used to fill the crack 20 and joints 30, as well as filling other matter in other embodiments. That gray crack and joint sealant may more closely approximate the color of typical roadways, such as those including Portland cement concrete or asphaltic concrete pavement, than existing ASTM-D6690 Type II-compliant crack and joint sealants. Embodiments of the gray crack and joint sealant may also or alternatively comply with one or both the ASTM-DD6690 Type I and III specifications.

In an embodiment, the gray crack and joint sealant includes a rosin ester (also referred to as pentaerythritol rosin ester or pentaerythritol ester of rosin) or a hydrocarbon ester (also referred to as hydrocarbon resin). The rosin ester or hydrocarbon ester may be used, such as instead of the asphalt that is used in some current black or darker sealants, to produce a gray binder. Both rosin ester and hydrocarbon ester may work sufficiently alone as a binder, and may also be used together in an embodiment as desired. Various rosin esters and hydrocarbon esters having various melting points may be used in the gray crack and joint sealant. In embodiments, such as any of those in Tables 1-3, Sylvalite® RE85L (rosin ester, i.e., pentaerythritol ester of rosin) or Sylvatac® RE85 (hydrocarbon resin), manufactured by Arizona Chemical, headquartered in Jacksonville, Fla., may be specifically used. In other embodiments, any other rosin ester and/or hydrocarbon resin, such as with a melting point at 100 degrees Celsius, 120 degrees Celsius, or another temperature, or another rosin ester and/or hydrocarbon resin may be used.

Resins and rosin esters may not have the same inherent properties of flexibility and stiffness as asphalt, though. Therefore, in an embodiment, the resin and/or rosin ester may be modified heavily with a styrene block copolymer, such as styrene butadiene styrene (SBS), and another polymer or polymers such as those mentioned below. The resin and/or rosin ester may be modified by a conventional heating method to provide flexibility. That modification may be expensive, however, and thus, in an embodiment, the mineral filler content of the gray crack and joint sealant may be extremely high as compared to standard asphalt-based binders.

In an embodiment, the mineral filler may be a nonabrasive, inert mineral filler that does not provide as much wear on the pumps of machinery that may be used to apply the sealant to cracks or joints such as compared to silica flour, makes the sealant less thick such as compared with fumed silica, and makes the sealant less dense such as compared with barium sulfate. Such a nonabrasive, inert mineral filler may include, in one embodiment, one or more of calcium carbonate, talc, kaolin clay, wollastonite, and magnesium carbonate.

In another embodiment, the mineral filler may be barite, silica flour, or fumed silica.

To provide a more liquid texture to the crack and joint sealant, there may be a high level of oil, such as naphthenic oil or another oil, and/or the crack and joint sealant may include one or more of polybutene and polyisobutene (also referred to as polyisobutylene). Substituting polybutene and/or polyisobutene for some or all of the oil may make for a less tacky sealant surface as compared to use of only oil, if desired. A less tacky surface of the sealant may decrease the chance that tire rubber of passing vehicles would collect on the sealant, darkening or blackening the sealant. Use of polybutene and/or polyisobutene may also reduce “greening,” or the turning of the gray crack and joint sealant partially green when overheated.

In an embodiment, titanium dioxide (TiO2) may be included in the crack and joint sealant to at least contribute to the crack and joint sealant's grayness.

A gray crack and joint sealant including the aforementioned substances, specific embodiments of which are provided below in Tables 1-3, may be aesthetically pleasing, yet still meet the requirements of the ASTM-D6690 Type II specification. If the gray crack and joint sealant has a high mineral content, that sealant may also be cost effective or cost competitive compared to black crack and joint sealants. The gray crack and joint sealant may be, as mentioned above, less distracting and thus safer to a driver because it may more closely approximate the color of the roadway in which it is applied, such as a roadway including Portland cement concrete or asphaltic concrete pavement or other roadway that is light gray or gray. Therefore, by using embodiments of the gray crack and joint sealant, the public may be better served by its state and local governments for not only aesthetic reasons, but safety reasons as well. Such a gray crack and joint sealant may, in various embodiments, be ASTM-D6690 Type I- and/or Type III-compliant in addition to or alternative to being ASTM-D6690 Type II-compliant.

In embodiments, the gray crack and joint sealant may have various materials, each having a range of concentrations. As used herein, the “concentration” of a substance of the gray crack sealant, such as provided in the embodiments of Tables 1 and 2, refers to the percentage of the mass of the gray crack sealant. Thus, for example, the styrene butadiene styrene (SBS) listed in Table 1 below has a concentration of 1.4 to 8 percent, and thus 1.4 to 8 percent of the mass of the gray crack sealant in Table 1 is SBS. As another example, one or more of polybutene, polyisobutene, and oil has a concentration of 7 to 20 percent, and thus one or the combination of more than one of polybutene, polyisobutene, and oil is, in total, 7 to 20 percent of the mass of the gray crack sealant in Table 1.

In one embodiment that may be ASTM-D6690 Type II-compliant and possibly ASTM-D6690 Type I- and/or Type III-compliant, the gray crack and joint sealant has the composition provided below in Table 1:

TABLE 1

| Substance | Concentration |
|---|---|
| one or more of polybutene, | 7-20% |
| polyisobutene, and oil | |
| styrene butadiene styrene (SBS) | 1.4-8% |
| ethyl vinyl acetate (EVA) | 0.5-1.5% |
| one or both of hydrocarbon | 5-20% |
| resin and rosin ester | |
| styrene isoprene styrene (SIS) | 0.5-6% |
| coloring pigment | 0.1-2% |
| antioxidant | 0.01-1% |
| nonabrasive, inert mineral filler | 45-80% |

In the gray crack and joint sealant embodiment of Table 1 above, the gray crack and joint sealant includes one or more substances selected from a group consisting of polybutene, polyisobutene, and oil at a concentration, and thus mass percentage, in total, of 7 to 20 percent. Thus, the crack and joint sealant includes 7 to 20 percent, in total, of one, or the combination of two or all three, of polybutene, polyisobutene, and oil. The combination may include, for example, two or all three of polybutene, polyisobutene, and oil in equal mass percentages or any other distribution of mass percentages as long as that combination, in total, is 7 to 20 percent of the concentration of the gray crack and joint sealant. For example, in one embodiment, the crack and joint sealant includes polybutene and polyisobutene, and the total mass combined of the polybutene and polyisobutene is 7 to 20 percent of the mass of the crack and joint sealant.

In an embodiment of the gray crack and joint sealant of Table 1, the one or more substances selected from the group consisting of polybutene, polyisobutene, and oil at a total concentration of 7 to 20 percent includes polybutene.

In another embodiment of the gray crack and joint sealant of Table 1, the one or more substances selected from the group consisting of polybutene, polyisobutene, and oil at a total concentration of 7 to 20 percent is polybutene. The polybutene may be, for example, at a 15.5 percent concentration, and thus 15.5 percent of the total mass of the crack and joint sealant, or at another concentration.

In an embodiment of the gray crack and joint sealant of Table 1, the one or more substances selected from the group consisting of polybutene, polyisobutene, and oil at a total concentration of 7 to 20 percent includes polyisobutene.

In an embodiment of the gray crack and joint sealant of Table 1, the one or more substances selected from the group consisting of polybutene, polyisobutene, and oil at a total concentration of 7 to 20 percent includes oil.

In an embodiment of the gray crack and joint sealant of Table 1, the styrene butadiene styrene (SBS) is at a concentration of 2.8 percent, and is thus 2.8 percent of the total mass of the crack and joint sealant.

In an embodiment of the gray crack and joint sealant of Table 1, the ethyl vinyl acetate (EVA) is at a concentration of 1 percent, and is thus 1 percent of the total mass of the crack and joint sealant.

In the gray crack and joint sealant embodiment of Table 1 above, the gray crack and joint sealant includes one or both substances selected from a group consisting of hydrocarbon resin and rosin ester at a concentration, and thus mass percentage, in total, of 5 to 20 percent. Thus, the crack and joint sealant includes 5 to 20 percent, in total, of one, or the combination of both, hydrocarbon resin and rosin ester. The combination may include, for example, hydrocarbon resin and rosin ester in equal mass percentages or any other distribution of mass percentages as long as that combination, in total, is 5 to 20 percent of the concentration of the gray crack and joint sealant.

In an embodiment of the gray crack and joint sealant of Table 1, the one or both substances selected from a group consisting of hydrocarbon resin and rosin ester are at a concentration of 11 percent, and are thus 11 percent, in total, of the mass of the crack and joint sealant.

In an embodiment of the gray crack and joint sealant of Table 1, the styrene isoprene styrene (SIS) is at a concentration of 2 percent, and is thus 2 percent of the total mass of the crack and joint sealant.

In an embodiment of the gray crack and joint sealant of Table 1, the coloring pigment is one or more of carbon black, titanium dioxide (TiO2), and iron oxide. Thus, the coloring pigment is one or more of carbon black, titanium dioxide (TiO2), and iron oxide such that the one, two, or three of those substances are, in total, 0.1 to 2 percent of the mass of the crack and joint sealant. In an embodiment, the coloring pigment is titanium dioxide, which may be at a concentration of 0.5 percent, and thus 0.5 percent of the total mass of the crack and joint sealant, or another concentration.

The antioxidant of the gray crack and joint sealant of Table 1 may be an ultraviolet stabilizer. The antioxidant may be at a concentration, for example, of 0.03 percent or another percentage, and thus 0.03 percent or another percent of the total mass of the crack and joint sealant.

In an embodiment of the gray crack and joint sealant of Table 1, the nonabrasive, inert mineral filler is one of, or one or more of, calcium carbonate, talc, kaolin clay, wollastonite, and magnesium carbonate such that the one or more than one of calcium carbonate, talc, kaolin clay, wollastonite, and magnesium carbonate are, in total, 45 to 80 percent of the mass of the crack and joint sealant. For example, the nonabrasive, inert mineral filler may be calcium carbonate, which may be at a concentration of 67.17 percent, and thus 67.17 percent of the total mass of the crack and joint sealant, or another concentration.

The gray crack and joint sealant of Table 1 (as well as Tables 2 and 3 below if desired) may be produced by mixing the listed chemical substances either dry or in heated liquid form. The gray crack and joint sealant may be produced through indirect heating methods, such as oil jacketing or another method. In an embodiment, the gray crack and joint sealant may be heated using indirect heating methods, such as by a method using a double boiler or a hot oil circulating kettle capable of constant material agitation. The product may then be applied to a roadway in a conventional or other manner.

In another embodiment, the gray crack and joint sealant may have a more specific concentration. Thus, in another embodiment that may be ASTM-D6690 Type II-compliant, the gray crack and joint sealant has the composition provided below in Table 2:

TABLE 2

| Substance | Concentration |
|---|---|
| polybutene | 15.5% |
| styrene butadiene styrene (SBS) | 2.8% |
| ethyl vinyl acetate (EVA) | 1% |
| hydrocarbon resin or rosin ester | 11% |
| styrene isoprene styrene (SIS) | 2% |
| coloring pigment | 0.5% |
| antioxidant | 0.03% |
| nonabrasive, inert mineral filler | 67.17% |

In an embodiment of the crack and joint sealant of Table 2, the nonabrasive, inert mineral filler includes one or more of calcium carbonate, talc, kaolin clay, wollastonite, and magnesium carbonate. For example, the nonabrasive, inert mineral filler may be calcium carbonate.

In an embodiment, the coloring pigment is one or more of carbon black, titanium dioxide (TiO2), and iron oxide. For example, the coloring pigment may be titanium dioxide.

The antioxidant of the gray crack and joint sealant of Table 2 may be an ultraviolet stabilizer.

In one embodiment that may be ASTM-D6690 Type II-compliant and possibly ASTM-D6690 Type I- and/or Type III-compliant, the gray crack and joint sealant has the composition provided below in Table 3:

TABLE 3

| Substance | Concentration |
|---|---|
| one or more of polybutene, | 7-20% |
| polyisobutene, and oil | |
| styrene block copolymer | 1.4-8% |
| ethyl vinyl acetate (EVA) | 0.5-1.5% |
| one or both of hydrocarbon | 5-20% |
| resin and rosin ester | |
| styrene isoprene styrene (SIS) | 0.5-6% |
| coloring pigment | 0.1-2% |
| antioxidant | 0.01-1% |
| one or more of calcium carbonate, | 45-80% |
| talc, kaolin clay, wollastonite, | |
| magnesium carbonate, barite, | |
| and fumed silica | |

As described above with respect to the crack and joint sealant of Table 1, the crack and joint sealant of Table 3 includes 7 to 20 percent, in total, of one, or the combination of two or all three, of polybutene, polyisobutene, and oil such that the total mass combined of that one, two, or three substances is 7 to 20 percent of the mass of the crack and joint sealant.

In an embodiment of the gray crack and joint sealant of Table 3, the styrene block copolymer is styrene butadiene styrene (SBS).

In an embodiment of the gray crack and joint sealant of Table 3, the one or more substances selected from the group consisting of polybutene, polyisobutene, and oil at a total concentration of 7 to 20 percent includes polybutene.

In another embodiment of the gray crack and joint sealant of Table 3, the one or more substances selected from the group consisting of polybutene, polyisobutene, and oil at a total concentration of 7 to 20 percent is polybutene. The polybutene may be, for example, at a 15.5 percent concentration, and thus 15.5 percent of the total mass of the crack and joint sealant, or at another concentration.

In an embodiment of the gray crack and joint sealant of Table 3, the styrene butadiene styrene (SBS) is at a concentration of 2.8 percent, and is thus 2.8 percent of the total mass of the crack and joint sealant.

In an embodiment of the gray crack and joint sealant of Table 3, the ethyl vinyl acetate (EVA) is at a concentration of 1 percent, and is thus 1 percent of the total mass of the crack and joint sealant.

As described above with respect to the crack and joint sealant of Table 3, the crack and joint sealant of Table 3 includes one or both substances selected from a group consisting of hydrocarbon resin and rosin ester at a concentration, and thus a combined total mass percentage of that one or two substances, of 5 to 20 percent.

In an embodiment of the gray crack and joint sealant of Table 3, the one or more substances selected from a group consisting of hydrocarbon resin and rosin ester is at a concentration of 11 percent, and is thus 11 percent of the total mass of the crack and joint sealant.

In an embodiment of the gray crack and joint sealant of Table 3, the styrene isoprene styrene (SIS) is at a concentration of 2 percent, and is thus 2 percent of the total mass of the crack and joint sealant.

In an embodiment of the gray crack and joint sealant of Table 3, the coloring pigment includes one or more of carbon black, titanium dioxide (TiO2), and iron oxide. In an embodiment, the coloring pigment is titanium dioxide, which may be at a concentration of 0.5 percent, and thus 0.5 percent of the total mass of the crack and joint sealant, or another concentration.

The antioxidant of the gray crack and joint sealant of Table 3 may be an ultraviolet stabilizer. The antioxidant may be at a concentration, for example, of 0.03 percent or another percentage, and thus 0.03 percent or another percent of the total mass of the crack and joint sealant.

In the gray crack and joint sealant embodiment of Table 3 above, the gray crack and joint sealant includes one or more substances selected from a group consisting of calcium carbonate, talc, kaolin clay, wollastonite, magnesium carbonate, barite, and fumed silica at a concentration of 45 to 80 percent. Thus, the crack and joint sealant includes 45 to 80 percent, in total, of one, or the combination of two or more, of calcium carbonate, talc, kaolin clay, wollastonite, magnesium carbonate, barite, and fumed silica. The combination may include, for example, two or more of the aforementioned substances in equal mass percentages or any other distribution of mass percentages as long as that combination, in total, is 45 to 80 percent of the mass of the gray crack and joint sealant.

In various embodiments, the concentrations provided in Tables 1 through 3 above do not reflect absolutes. Instead, those concentrations or ranges of concentrations reflect values that are typical and may vary. In embodiments, those concentration ranges and concentrations are about as listed.

In embodiments, the crack and joint sealants provided in Tables 1 through 3 and elsewhere herein include the substances provided, but may include other substances as well.

Gray crack and joint sealant embodiments herein, as noted herein, may be ASTM-D6690 Type II-compliant. Thus, for example, those crack and joint sealants may meet ASTM-D6690 Type II test requirements such as those listed below in Table 4:

TABLE 4

| Test | Requirements | |
|---|---|---|
| Cone Penetration | 90 | Maximum |
| Flow | 3 mm | Maximum |
| Softening Point | 176° F. | Minimum |
| Resilience | 60% | Minimum |

| | |
|---|---|
| Bond, −20° F. , 50% Extension | Pass 3 Cycles |
| Minimum Application Temp. | 380° F. |
| Maximum Heating Temp. | 400° F. |

Various embodiments of the gray crack and joint sealant disclosed herein may be hot applied single component sealants. Those gray crack and joint sealants may have several properties that facilitate their use, such as the ability to cohesively bond to concrete, flexibility, self-leveling for easy and efficient application, resistance to ultraviolet light, insolubility in water, and stability under normal conditions. In one or more stages of production or application, embodiments of the gray crack and joint sealant provided herein may have a resin odor and may be in the form of a powder, and/or may have other properties.

After manufacturing, various embodiments of the gray crack and joint sealant may be supplied as desired, such as in solid form and packaged in a 50 pound cardboard box with a meltable plastic liner, or in 30 pound melt bags. The weight may be 14.8 pounds per gallon or another weight. The shelf life may be two years or another shelf life.

While specific embodiments of the invention have been described in detail, it should be appreciated by those skilled in the art that various modifications and alternations and applications could be developed in light of the overall teachings of the disclosure. For example, though the crack and joint sealant embodiments herein have been described as applicable to roadways, those crack and joint sealants may be applied to sidewalks, parking lots and structures, bridge decks, concrete pavements, and other matter that includes Portland cement concrete or asphaltic concrete pavement and possibly other such concretes and pavements. Accordingly, the particular arrangements, products, and methods disclosed are meant to be illustrative only and not limiting as to the scope of the invention.

What is claimed is:

1. A crack and joint sealant, comprising, by percentage of the mass of the crack and joint sealant:
about 7 to 20 percent, in total, of one or more substances selected from a group consisting of polybutene, polyisobutene, and oil;
about 1.4 to 8 percent styrene butadiene styrene (SBS);
about 0.5 to 1.5 percent ethyl vinyl acetate (EVA);
about 5 to 20 percent, in total, of one or both substances selected from a group consisting of hydrocarbon resin and rosin ester;
about 0.5 to 6 percent styrene isoprene styrene (SIS);
about 0.1 to 2 percent coloring pigment;
about 0.01 and 1 percent antioxidant; and
about 45 to 80 percent of a nonabrasive, inert mineral filler;
wherein the crack and joint sealant is at least one of ASTM-D6690 Type I-compliant, ASTM-D6690 II-compliant, and ASTM-DD690 Type III-compliant.

2. The crack and joint sealant of claim 1, wherein the one or more substances selected from a group consisting of polybutene, polyisobutene, and oil includes polybutene.

3. The crack and joint sealant of claim 1, wherein the one or more substances selected from a group consisting of polybutene, polyisobutene, and oil is polybutene.

4. The crack and joint sealant of claim 3, wherein the polybutene is present in the amount of about 15.5 percent.

5. The crack and joint sealant of claim 1, wherein the one or more substances selected from a group consisting of polybutene, polyisobutene, and oil includes polyisobutene.

6. The crack and joint sealant of claim 1, wherein the one or more substances selected from a group consisting of polybutene, polyisobutene, and oil includes oil.

7. The crack and joint sealant of claim 1, wherein the SBS is present in the amount of about 2.8 percent.

8. The crack and joint sealant of claim 1, wherein the one or both substances selected from a group consisting of hydrocarbon resin and rosin ester are present in an amount, in total, of about 11 percent.

9. The crack and joint sealant of claim 1, wherein the SIS is present in an amount of about 2 percent.

10. The crack and joint sealant of claim 1, wherein the EVA is present in an amount of about 1 percent.

11. The crack and joint sealant of claim 1, wherein the coloring pigment includes one or more of carbon black, titanium dioxide, and iron oxide.

12. The crack and joint sealant of claim 1, wherein the coloring pigment is titanium dioxide.

13. The crack and joint sealant of claim 1, wherein the nonabrasive, inert mineral filler is calcium carbonate.

14. The crack and joint sealant of claim 1, wherein the nonabrasive, inert mineral filler includes one or more of calcium carbonate, talc, kaolin clay, wollastonite, and magnesium carbonate.

15. The crack and joint sealant of claim 1, wherein the nonabrasive, inert mineral filler includes one of calcium carbonate, talc, kaolin clay, wollastonite, and magnesium carbonate.

16. The crack and joint sealant of claim 1, wherein the substance selected from the group consisting of hydrocarbon resin and rosin ester is rosin ester.

17. The crack and joint sealant of claim 1, wherein the substance selected from the group consisting of hydrocarbon resin and rosin ester is hydrocarbon resin.

18. The crack and joint sealant of claim 1, wherein the antioxidant is present in an amount of about 0.03 percent.

19. The crack and joint sealant of claim 1, wherein the crack and joint sealant is ASTM-D6690 Type I-compliant.

20. The crack and joint sealant of claim 1, wherein the crack and joint sealant is ASTM-D6690 Type II-compliant.

21. The crack and joint sealant of claim 1, wherein the crack and joint sealant is ASTM-D6690 Type III-compliant.

22. A crack and joint sealant, comprising, by percentage of the mass of the crack and joint sealant:
about 15.5 percent polybutene;
about 2.8 percent styrene butadiene styrene (SBS);
about 1 percent ethyl vinyl acetate (EVA);
about 11 percent of a substance selected from the group consisting of hydrocarbon resin and rosin ester;
about 2 percent styrene isoprene styrene (SIS);
about 0.5 percent coloring pigment;
about 0.03 percent antioxidant; and
about 67.17 percent of a nonabrasive, inert mineral filler.
wherein the crack and joint sealant is at least one of ASTM-D6690 Type I-compliant, ASTM-D6690 II-compliant, and ASTM-DD690 Type III-compliant.

23. A crack and joint sealant, comprising, by percentage of the mass of the crack and joint sealant:
about 7 to 20 percent, in total, of one or more substances selected from a group consisting of polybutene, polyisobutene, and oil;
about 1.4 to 8 percent styrene block copolymer;
about 0.5 to 1.5 percent ethyl vinyl acetate (EVA);
about 5 to 20 percent, in total, of one or both substances selected from a group consisting of hydrocarbon resin and rosin ester;
about 0.5 to 6 percent styrene isoprene styrene (SIS);
about 0.1 to 2 percent coloring pigment;
about 0.01 and 1 percent antioxidant; and
about 45 to 80 percent, in total, of one or more substances selected from a group consisting of calcium carbonate, talc, kaolin clay, wollastonite, magnesium carbonate, barite, and fumed silica;
wherein the crack and joint sealant is at least one of ASTM-D6690 Type I-compliant, ASTM-D6690 II-compliant, and ASTM-DD690 Type III-compliant.

24. The crack and joint sealant of claim 23, wherein the styrene block copolymer is styrene butadiene styrene (SBS).

25. The crack and joint sealant of claim 23, wherein the coloring pigment includes one or more of carbon black, titanium dioxide, and iron oxide.
